(19) United States
(12) Patent Application Publication
(10) Pub. No.: US 2024/0365727 A1
(43) Pub. Date: Nov. 7, 2024

(54) IRRIGATION DEVICES, SYSTEMS INCLUDING THE SAME, AND METHODS OF USING THE SAME

(71) Applicants: Brent E. Henry, Salt Lake City, UT (US); James D. Henry, Woods Cross, UT (US)

(72) Inventors: Brent E. Henry, Salt Lake City, UT (US); James D. Henry, Woods Cross, UT (US)

(21) Appl. No.: 18/652,341

(22) Filed: May 1, 2024

Related U.S. Application Data
(60) Provisional application No. 63/464,363, filed on May 5, 2023.

(51) Int. Cl. A01G 25/09

(52) U.S. Cl. CPC A01G 25/09

(57) ABSTRACT

An example irrigation device includes a housing and at least one drive system configured to move the housing. The irrigation device further includes at least one fluid delivery nozzle disposed in or attached to the housing. The fluid delivery nozzle is configured to controllably and selectively dispense a fluid. The irrigation device also includes a controller configured to direct the drive system to move the housing and the fluid delivery nozzle to dispense the fluid. The irrigation device also includes at least one of a hose attached to the housing, the housing includes a fluid inlet attachable to the hose, a power cable attached to the housing, or the housing includes a power inlet attachable to the power cable.

### CROSS-REFERENCE TO RELATED APPLICATION(S)

This application claims priority to U.S. Provisional Patent Application No. 63/464,363 filed on May 5, 2023, the disclosure of which is incorporated herein, in its entirety, by this reference.

### BACKGROUND

Most lawn and plant irrigation systems use simple delivery systems that spray water in circular or angled distributions with overlapping zones. These inexact delivery systems result in some areas receiving excess water and others not receiving enough. In addition, these delivery systems are prone to problems with low pressure, clogging, tilting, breaking, and jamming such that they often do not deliver water evenly to the intended area. Water delivery to these sprinkler heads is controlled via simple timer systems that turn large zones on and off at pre-programmed times. Some more advanced systems also include local weather and temperature data to help dynamically adjust water amounts or skip watering when it's raining. However, with all the complexity described above, it's common to encounter unhealthy plants and unhealthy spots in the lawn. The typical response to fix unhealthy plants and lawn is to increase the watering and chemical distribution until the health of the problem spot improves, which often results in other areas receiving many times more water and chemicals than required.

### SUMMARY

Embodiments are directed to irrigation devices (e.g., mobile irrigation device), systems including the same, and methods of using the same. In an embodiment, an irrigation device is disclosed. The irrigation device includes a housing, at least one drive system configured to move the housing, and at least one fluid delivery nozzle disposed in or attached to the housing. The at least one fluid delivery nozzle is configured to controllably and selectively dispense a fluid. The irrigation also includes a controller configured to direction the at least one drive system to move the housing and the at least one fluid delivery nozzle to dispense the fluid. The irrigation device further includes at least one of: a hose attached to the housing and/or the housing includes a fluid inlet attachable to the hose or a power cable attached to the housing and/or the housing includes a power inlet attachable to the power cable. The hose is configured to supply the fluid to at least one of the housing or the at least one fluid delivery nozzle. The irrigation device may not include a fluid storage tank when the irrigation device includes the hose. The power cable is configured to supply electrical power to one or more components housed in and/or attached to the housing. The irrigation device may not include a device powering battery when the irrigation device includes the power cable.

In an embodiment, a system is disclosed. The system includes an irrigation device The irrigation device includes a housing, at least one drive system configured to move the housing, and at least one fluid delivery nozzle disposed in or attached to the housing. The at least one fluid delivery nozzle is configured to controllably and selectively dispense a fluid. The irrigation also includes a controller configured to direction the at least one drive system to move the housing and the at least one fluid delivery nozzle to dispense the fluid. The irrigation device further includes at least one of: a hose attached to the housing and/or the housing includes a fluid inlet attachable to the hose or a power cable attached to the housing and/or the housing includes a power inlet attachable to the power cable. The hose is configured to supply the fluid to at least one of the housing or the at least one fluid delivery nozzle. The irrigation device may not include a fluid storage tank when the irrigation device includes the hose. The power cable is configured to supply electrical power to one or more components housed in and/or attached to the housing. The irrigation device may not include a device powering battery when the irrigation device includes the power cable. The system also includes a stationary dock, wherein at least one of the hose extends between and is attached to the irrigation device and the stationary dock or the power cable extends between and is attached to the irrigation device and the stationary dock.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIGS. 1A and 1B are side and top schematic views, respectively, of an irrigation device, according to an embodiment.

FIGS. 2A and 2B are side and top schematic views, respectively, of an irrigation device including a water tank, according to an embodiment.

FIGS. 3A and 3B are side and top schematic views, respectively, of an irrigation device including a battery, according to an embodiment.

FIGS. 4A and 4B are side and top schematic views, respectively, of an irrigation device, according to an embodiment.

FIG. 5 is a schematic view of an irrigation system including an irrigation device and a stationary dock, according to an embodiment.

FIG. 6 is a schematic view of an irrigation system, according to an embodiment.

### DETAILED DESCRIPTION

Embodiments are directed to irrigation devices (e.g., mobile irrigation device), systems including the same, and methods of using the same. An example irrigation device includes a housing and at least one drive system configured to move the housing. The irrigation device further includes at least one fluid delivery nozzle disposed in or attached to the housing. The fluid delivery nozzle is configured to controllably and selectively dispense a fluid. The irrigation device also includes a controller configured to direct the drive system to move the housing and the fluid delivery nozzle to dispense the fluid. The irrigation device also includes at least one of a hose attached to the housing, the housing includes a fluid inlet attachable to the hose, a power cable attached to the housing, or the housing includes a power inlet attachable to the power cable. The fluid hose is configured to supply the fluid to at least one of the housing or the fluid delivery nozzle and the power cable is configured to supply electrical power to one or more components of the irrigation device. When the irrigation device includes the hose or the fluid inlet, the irrigation device may not include a fluid storage tank. When the irrigation device includes the power cable or the power inlet, the irrigation device does not include a device powering battery.

On an automated schedule, the irrigation device may drive out to an area where lawn or plants need to be cared for, precisely deliver fluid by rotating or elevating (e.g., tilting) the irrigation device's delivery nozzle and/or varying water pressure, track where the fluid was delivered, and then move on to the next area. The mobile irrigation device may form part of an automated irrigation system. The mobile irrigation device may allow for close up access to continuously monitor the health of lawns and plants and automatically and precisely direct water, fertilizer, and herbicides as needed to each individual plant and each small section of lawn to maintain optimal lawn and plant health. Close up access enables to the irrigation device to irrigate plants even with wind, complex and changing terrain, and unexpected obstacles. The close up access and precise control of the irrigation device may allow for accurate tracking of prior delivery of water and chemicals to each plant and each small section of lawn and then allow for experiments with varying levels in future deliveries to determine optimal amounts and timings for each.

The irrigation device may form part of a larger system. For example, the system may include a stationary dock. The stationary dock is coupled to the irrigation device such that fluids and/or electrical power is provided from the stationary dock to the irrigation device. For example, the hose and/or the power cable may extend between and be attached to the irrigation device and the stationary dock. The hose is configured to supply a fluid (e.g., water, liquid fertilizer, liquid insecticide, another fluid, or combinations of any of the foregoing) from the stationary dock to the irrigation device and the power cable may be configured to provide electrical power from the stationary dock to the irrigation device. The stationary dock may be attached to a fluid source (e.g., a hose spigot) and/or an electrical power source (e.g., an electrical outlet). Supplying the fluid and/or the electrical power from the stationary dock to the irrigation device reduces the weight of the irrigation device since the irrigation device does not need to include a water storage tank and/or a battery. Further, supplying the fluid and/or electrical power from the stationary dock to the irrigation device prevents the irrigation device having to return to a location to receive additional fluids and/or changer a battery of the irrigation device. As such, the irrigation device and the system including the irrigation device may be an improvement over conventional irrigation devices that include a fluid storage tank and a battery.

The irrigation device and the system including the irrigation device may be able to continuously monitor the health of lawns and plants and automatically and precisely direct water, fertilizer, and herbicides as needed to each individual plant and each small section of lawn to maintain optimal lawn and plant health. The system tracks history of prior delivery of water, and chemicals to each plant and each small section of lawn and then experiments with varying levels in future deliveries to determine optimal amounts and timings for each.

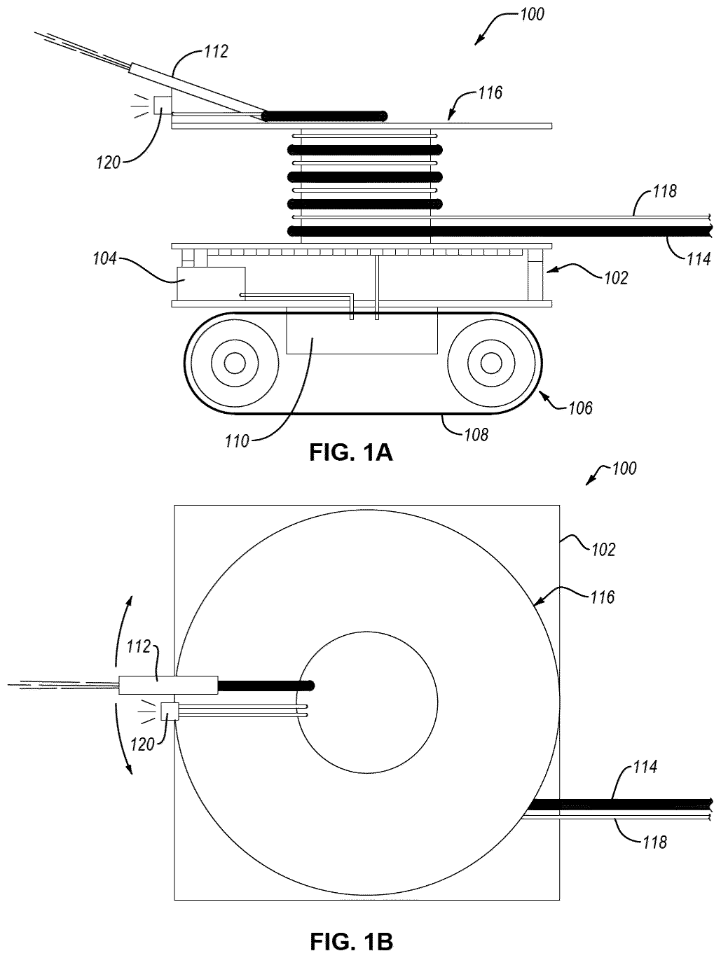

FIGS. 1A and 1B are top and side schematic views of an irrigation device 100, according to an embodiment. The irrigation device 100 may include a housing 102 configured to hold and/or have attached thereto one or more components of the irrigation device 100. In an embodiment, the housing 102 may include a plate and the components of the irrigation device may be attached to the plate. Forming the housing 102 from a plate may minimize the weight of the housing 102 thereby allowing the irrigation device 102 to operate with minimal energy and/or allow the irrigation device 100 to carry heavy components (e.g., a water tank or a battery). In an embodiment, the housing 102 may include at least one water tight compartment 104. The water tight compartment 104 may contain the controller (not shown, within compartment 104) to ensure that it is protected from water. The water tight compartment 104 may also include other components of the irrigation device 100 that may be damaged (e.g., oxidized, short-circuited, etc.) when exposed to water. In an embodiment, the housing 102 may include at least one non-water tight compartment 104. The non-water tight compartment 104 may provide physical protection to the components of the irrigation device 100, improve the appearance of the irrigation device 100, and may still provide some protection to the components of the irrigation device 100 from water exposure.

In an embodiment, the housing 102 may include (e.g., consist of essentially of or consist of) plastic to keep it lightweight and durable. For example, at least a majority of the housing 102 may be plastic. In an embodiment, the housing 102 may include metal. For example, the portions of the housing 102 at or near the drive system 106 may include metal to ensure that the housing 102 at or near the drive system 106 is strong enough to handle the movement of the housing 102.

The irrigation device 100 may include a drive system 106 attached to the housing 102. The drive system 106 is configured to controllably move the housing 102 and the components of the irrigation device 100 that are attached to the housing 102. The drive system 106 may make use of wheels or tracks 108. The wheels or tracks 108 of the drive system 106 are configured to achieve sufficient traction to allow reliable navigation of the irrigation device 100 in the area to be irrigated.

The drive system 106 may make use of at least one electric motor 110. The electric motor 110 is configured to move (e.g., rotate) the wheels or tracks 108 to impart motion to the irrigation device 100. In an embodiment, the drive system 106 may include at least two electric motors 110 to allow for independent control of wheels or tracks 108, allowing full maneuverability of the irrigation device 100, including rotating in place. For example, the drive system 106 may include at least one first electric motor configured to drive the wheels or tracks 108 on one side of the housing 102 and at least one second electric motor configured to drive the wheels or tracks 108 on an opposing side of the housing 102. In an embodiment, the at least one electric motor 110 may be positioned within the housing 102 or below the housing 102 to prevent water dispensed from the fluid delivery nozzle 112 or leaking from the hose 114 from reaching the electric motor.

The drive system 106 may include wheels, tracks, or any other suitable device. The wheel may be used for a simpler and more durable design, but tracks 108 may allow for increased traction and better handling of uneven surfaces and may also be used in the design. In an embodiment, the wheels or tracks 108 may include protrusions (e.g., ridges extending perpendicular or substantially perpendicular to the circumference of the wheels or tracks 108), recesses, treads, or other structures to improve traction between the wheels or tracks 108 and the ground, which may be important when the irrigation device 100 is navigating hills, wet (e.g., muddy) terrain, or moving over loose matter (e.g., gravel, fallen leaves, grass clippings, etc.). In an embodiment, the wheels or tracks 108 may include rims, spokes, or other structure extending from a center of rotation (e.g., axle) to the outer portion of the wheels or tracks 108. In a particular example, the wheels or tracks 108 may include a circular plate-like structure extending from the center of rotation to the outer portion of the wheels or tracks 108 to improve durability of the wheels or tracks 108. In such an example, the circular plate-like structure may include a plurality of cutouts to decrease the weight of the wheels or tracks 108 and/or increase the bending strength of the circular plate-like structure. It is noted that the irrigation device 100 may include wheels or tracks 108 that are distinct from the drive system 106, such as wheels or tracks that are not attached to electric motors, are allowed to freely move, and provided improve the stability (e.g., balance, better distribute the weight, etc.) to the irrigation device 100. It is also noted that the irrigation device 100 may include movement inducing elements other than or in addition to the wheels or tracks 108, such as articulable legs.

The irrigation device 100 may include any suitable number of wheels or tracks (e.g., the wheels or tracks 108 that form part of the drive system 106 or other wheels or tracks that are distinct from the drive system 106). In an example, the irrigation device 100 includes two or more wheels or tracks (e.g., two, three, four, five, six, seven, or eight or more wheels or tracks), with at least one wheel or track on each lateral side of the housing 102.

The drive system 106 may be configured to move the irrigation device 100 at an average or maximum velocity of about 1 cm/s to about 5 cm/s, about 2.5 cm/s to about 7.5 cm/s, about 5 cm/s to about 10 cm/s, about 7.5 cm/s to about 15 cm/s, about 10 cm/s to about 20 cm/2s, about 15 cm/s to about 25 cm/s, about 20 cm/s to about 30 cm/s, about 25 cm/s to about 35 cm/s, about 30 cm/s to about 40 cm/s, about 35 cm/s to about 45 cm/s, about 40 cm/s to about 50 cm/s, about 45 cm/s to about 60 cm/s, about 50 cm/s to about 70 cm/s, about 60 cm/s to about 80 cm/s, about 70 cm/s to about 90 cm/s, about 80 cm/s to about 1 m/s, about 90 cm/s to about 1.25 m/s, about 1 m/s to about 1.5 m/s, about 1.25 m/s to about 2 m/s, or about 2 m/s or greater. In a particular embodiment, the drive system 106 may not need to move the irrigation device 100 faster than approximately 32 cm/s because the irrigation device 100 will spend minutes in each location as it delivers fluid and may move short distances with each change of location as irrigation device 100 covers its assigned area. This slow drive speed requirement will allow for a simpler and lower-power drive system 106 with increased durability.

The irrigation device 100 includes at least one fluid delivery nozzle 112 configured to dispense a fluid (e.g., water) towards a desired location. The fluid delivery nozzle 112 may be attached to, either directly or indirectly, to the housing 102. In an embodiment, the fluid delivery nozzle 112 is attached to or near a top side of the housing 102, which is the side of the housing 102 opposite the ground to maximize the height of the fluid delivery nozzle 112. It is noted that maximizing the height of the fluid delivery nozzle 112 maximizes the distance that the fluid delivery nozzle 112 can dispense the fluid.

The fluid delivery nozzle 112 may be rotated and/or elevated (e.g., tilted, raised, or otherwise angled) to precisely control delivery of fluids to a targeted location near the irrigation device 100. In an example, the fluid delivery nozzle 112 may be configured to be about 30 cm or closer, about 20 cm or closer, or about 15 cm or close to the desired location before the fluid delivery nozzle 112 dispenses a fluid. In other words, the fluid delivery nozzle 112 may be configured to spray fluids about 10 cm to about 30 cm. In an example, the fluid delivery nozzle 112 may be configured to spray fluid greater than 30 cm, such as in ranges of about 30 cm to about 50 cm, about 40 cm to about 75 cm, about 50 cm to about 1 m, about 75 cm to about 1.5 m, about 1 m to about 2 m, about 1.5 m to about 2.5 m, about 2 m to about 3 m, about 2.5 m to about 3.5 m, about 3 m to about 4 m, about 3.5 m to about 4.5 m, about 4 m to about 5 m, about 4.5 m to about 5.5 m, or greater than 5 m. The fluid delivery nozzle 112 may be attached to a motor (not shown) that allows it to be adjusted along at one of the x axis (i.e., side-to-side), the y axis (i.e., forwards and backwards), the z-direction (i.e., up and down), the pitch direction (i.e., rotate about the x axis), the roll direction (i.e., rotate about the y axis), or the yaw direction (i.e., rotate about the z axis).

The fluid delivery nozzle 112 may include a simple round opening that forms a simple round water stream arc. Because the fluid delivery nozzle 112 can direct the fluid exactly to or near a desired location, the fluid delivery nozzle 112 may not need to define a plurality of openings to form a more complex spray targeting a larger area. That said, the fluid delivery nozzle 112 may define a plurality of openings. The fluid delivery nozzle 112 may be configured to dispense the fluid in at least one of a jet-like pattern, a full cone pattern, a flat spray pattern, a full cone square pattern, a hollow cone pattern, an atomizing or fine spray pattern, any other suitable pattern, or combinations thereof.

In an embodiment, the fluid delivery nozzle 112 may have at least one motor configured to adjust the elevation of the fluid delivery nozzle 112. In an embodiment, the fluid delivery nozzle 112 does not include a motor configured to adjust the elevation thereof. Instead, the fluid delivery nozzle 112 may exhibit a fixed elevation angle. In such an embodiment, the water pressure of the fluid provided to the fluid delivery nozzle 112 may be adjusted (e.g., using a stationary dock and/or a valve) to adjust the distance from the fluid delivery nozzle 112 to where the water is delivered. In an embodiment, the fluid delivery nozzle 112 may have at least one motor configured to otherwise move the fluid delivery nozzle 112 with or without changing the elevation of the fluid delivery nozzle 112, such as rotation the nozzle about the z axis (i.e., vertical axis).

In an embodiment, as shown, the irrigation device 100 may include a single fluid delivery nozzle 112. In an embodiment, the irrigation device 100 may include a plurality of fluid delivery nozzles 112. The plurality of fluid delivery nozzles 112 may facilitate delivery of the fluid in different applications. For example, the plurality of fluid delivery nozzles 112 may include a “jet” nozzle (e.g., high pressure nozzle) that is configured to deliver the fluid to an area that is partially obstructed by loose objects (e.g., deliver water to roots that are at least partially obstructed by leaves); a cone, spray, or other wide area nozzle to deliver the fluid to a wide area; and/or a “soaker” type nozzle (e.g., low pressure nozzle) that is configured to apply a relatively large quantity of fluid to a small area.

In an embodiment, the irrigation device 100 is configured to change the pressure of the fluid dispensed from the fluid delivery nozzle 112. Adjusting the pressure of the fluid dispensed from the fluid delivery nozzle 112 allows the distance between the fluid delivery nozzle 112 and the desired location to be controllably varied, allows the force of the fluid to be controllably changed (e.g., a low pressure fluid to be dispensed to an area prone to erosion, such as exposed dirt and a high pressure fluid to be dispense to an area that is partially obstructed by leaves). The pressure of the fluid may be controlled using any suitable device, such as decreasing the size of the orifice of the fluid delivery nozzle 112 or using a valve to control the amount of fluid provide to the fluid delivery nozzle 112. In an embodiment, the fluid delivery nozzle 112 is configured to change the spray angle of the fluid delivery nozzle 112.

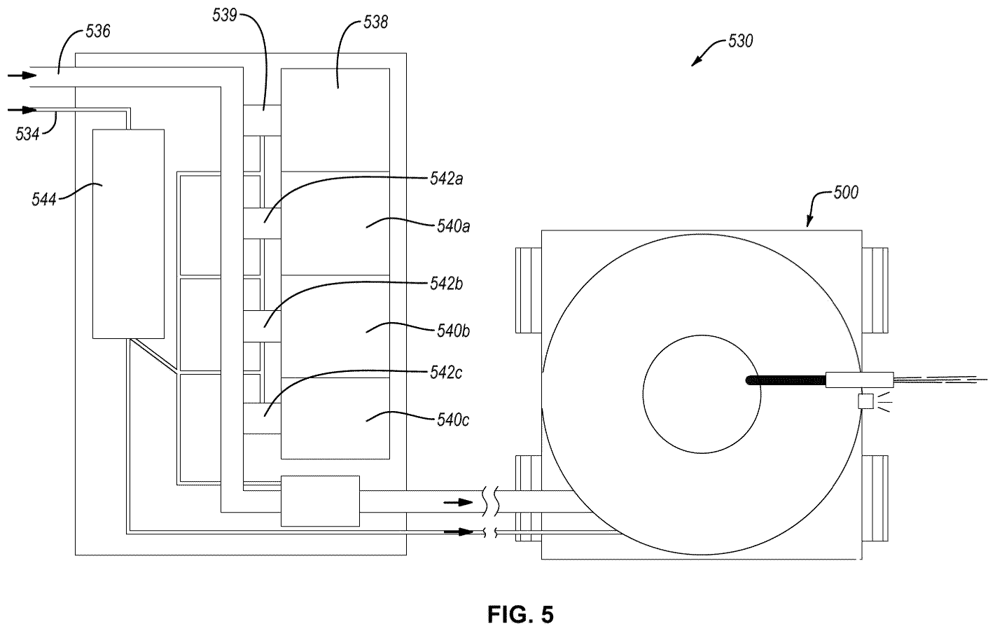

In an embodiment, the irrigation device 100 includes a hose 114 and/or a fluid inlet (not shown) configured to be attached to the hose 114. The hose 114 extends between and is attached to (e.g., is tethered) a stationary dock (e.g., stationary dock shown in FIGS. 5-7) thereby allowing fluid to be delivered to the irrigation device 100. In other words, the fluid hose 114 allows the irrigation device 100 to free of a fluid storage tank. This ability to deliver the fluid to the irrigation device 100 without using a fluid storage tank significantly reduces the weight that the irrigation device 100 has to carry, which reduces the size and complexity of the drivetrain, power source, and housing 102. The hose 114 also allows the irrigation device 100 to continuously operate (e.g., water a lawn) without having to make as many trips out and back to refill the irrigation device 100 with fluids, which extends durability and increases efficiency of the irrigation device 100. Since the irrigation device 100 does not need to move as quickly to accommodate the trips out and back to refill the irrigation device 100, the drive system 106 can be kept slow, simple, and durable. An optional mechanism for climbing steep terrain or stairs may be included to expand terrain handling capabilities. Such an optional mechanism for climbing steep terrain or stair may include, for example, tracks 108 in the drive system 106 configured to traverse steep terrain (e.g., elongated tracks) or a large 3-wheel cluster that rotates.

The irrigation device 100 may include a hose spool 116 configured to hold the hose 114. The hose spool 116 may be configured to spool or unspool the hose 114, as needed. The hose spool 116 may be configured to spool or unspool the hose 114 at the same speed that the drive train moves the housing 102.

In an embodiment, the hose 114 may include ¼ in outer diameter polyethylene micro distribution tubing, such as drip line distribution tubing. This tubing is lightweight, flexible, durable, does not degrade in the sun, does not easily kink, and is easily connected and spliced using simple barbed connectors. In an embodiment, the hose 114 may include other types of hoses, such as a hose exhibiting an outer diameter less than or greater than ¼ in or a hose formed of a material other than polyethylene.

The hose 114 may exhibit a length of about 5 m or greater, about 10 m or greater, about 15 m or greater, about 20 m or greater, about 25 m or greater, about 30 m or greater, about 35 m or greater, about 40 m or greater, about 45 m or greater, about 50 m or greater, about 60 m or greater, about 75 m or greater, or in ranges of about 5 m to about 15 m, about 10 m to about 20 m, about 15 m to about 25 m, about 20 m to about 30 m, about 25 m to about 35 m, about 30 m to about 40 m, about 35 m to about 45 m, about 40 m to about 50 m, about 45 m to about 60 m, or about 50 m to about 75 m. For example, a hose 114 exhibiting a length of about 30 m may allow full reach to all areas in an average-sized yard without weighing more than a few pounds when the hose 114 is fully spooled.

In an embodiment, the irrigation device 100 includes a power cable 118 or a power inlet (not shown) that is configured to be attached to the power cable 118. The power cable 118 extends between and is attached to (e.g., is tethered) to the stationary dock. The power cable 118 provides continuous power to the irrigation device 100 thereby eliminating the need for a device powering battery stored on the irrigation device 100 and/or a separate charging apparatus configured to charge the device power battery. In other words, the irrigation device 100 may not include a device powering battery when the irrigation device 100 includes the power cable 118. This ability to provide electrical to the irrigation device 100 with the power cable 118 (i.e., without using a device power battery) significantly reduces the weight that the irrigation device 100 has to carry, which reduces the size and complexity of the drive system 106, power source, and housing 102. The power cable 118 also allows the irrigation device 100 to continuously operate (e.g., water a lawn) without having to make as many trips out and back to recharge the device powering battery, which extends durability and increases efficiency of the irrigation device 100. Since the irrigation device 100 does not need to move as quickly to accommodate the trips recharge the irrigation device 100, the drive system 106 can be kept slow, simple, and durable.

It is noted that, as used herein, “device powering battery” refers to a battery having sufficient charge and power to operate the irrigation device 100 for a prolonged period of time (e.g., periods of time greater than 3 minutes). The device powering battery does not include smaller batteries such as batteries configured to operate individual components of the irrigation device 100, smaller batteries configured to send and/or receive data via a transceiver in case of power outages, or smaller batteries that return the irrigation device 100 to a location (e.g., the stationary dock) in case of power outages. In an embodiment, the irrigation device 100 may include a battery that is not a device powering battery, such as any of the smaller batteries discussed above, since such batteries do not significantly affect the weight of the irrigation device 100 nor require constant recharging to the batteries to operate the irrigation device 100. In an embodiment, the irrigation device 100 does not include any batteries large enough to operate the drive system 106 since such batteries may be large and heavy. In an embodiment, the irrigation device 100 does not include any batteries.

The power cable 118 may include, for example, a small gauge light weight cable like 24 AWG 8 conductor Cat5e ethernet cable, which would allow for data transmission as well as power using the Power Over Ethernet (POE) or other standard. The power cable 118 may exhibit the same length as the hose 114. The power cable 118 may be integrally formed together with the hose 114 or may be a separate cable. In an example, when the power cable 118 is separate from the hose 114, the power cable 118 may be twisted around, braided with, or otherwise attached to the hose 114 (e.g., using tape or an adhesive) which allows the hose 114 and the power cable 118 to effectively act like a single cable. Causing the hose 114 and the power cable 118 to effectively act like a single cable may facilitate dispensing and retrieving the hose 114 and the power cable 118, avoid entangling the hose 114 and the power cable 118 around obstacles, and decrease the likelihood that the hose 114 and the power cable 118 become tangled with each other.

In an embodiment, the power cable 118 may wind up in the hose spool 116 and then be connected to the housing 102 with a standard ethernet connection.

In an embodiment, the irrigation device 100 may include a data cable configured to transmit data to and from the irrigation device 100. In an example, the data cable is distinct from the power cable 118. In an example, the power cable 118 is also the data cable (i.e., the power cable 118 provide power to the irrigation device 100 and transmits data to and from the irrigation device 100).

In an embodiment, the power cable 118 is a Cat5e ethernet cable which allows power and data to be provided to the irrigation device 100 and allows data transmission rates of 1 Mbs or more (e.g., 1 Mbs to about 10 Mbs, about 5 Mbs to about 25 Mbs, about 20 Mbs to about 50 Mbs, about 40 Mbs to about 70 Mbs, about 60 Mbs to about 100 Mbs, or greater than 100 Mbs) using the standard IP protocol. However, the irrigation device 100 may also communicate through other means, such as a smaller gauge cable to allow for more power, or wirelessly using Wifi, Bluetooth, etc. Data transmitted may include images collected by the system, monitoring updates, location information, and instructions for future movement and irrigation.

In an embodiment, the irrigation device 100 includes at least one spool. The at least one spool may include the hose spool 116 and/or one or more additional spools. The spool is configured manage the hose 114 and/or the power cable 118. The spool is configured to coordinate with the movement of the irrigation device 100. For example, the spool may dispense the hose 114 and power cable 118 as the irrigation device 100 moves away from the stationary dock. For instance, the spool dispenses the hose 114 and the power cable 118 at substantially the same rate that the irrigation device 100 moves away from the stationary dock which prevents or minimizes tension on the hose 114 and the power cable 118 and prevents too much slack being present in the hose 114 and the power cable 118. Minimizing tension in the hose 114 and the power cable 118 may prevent or minimize the hose 114 and the power cable 118 from pulling on (e.g., braking) the irrigation device 100, prevent the hose 114 and/or the power cable 118 from becoming detached from the irrigation device 100 or the stationary dock, and may prevent damage to one or more components of the irrigation device 100. Preventing too much slack in the hose 114 and the power cable 118 may prevent or at least inhibit tangling of the fluid hose 114 and the power cable 118. The spool may further roll the hose 114 and the power cable 118 back up as the irrigation device 100 moves back toward the stationary dock. In an example, when the irrigation device 100 follows the same path that the hose 114 and the power cable 118 are laid, the spool rolls the hose 114 and the power cable 118 back up at a speed that corresponds to the speed that the irrigation device 100 moves, again, to prevent tensioning the hose 114 and/or the power cable 118 and/or prevents undesired slack in the hose 114 and the power cable 118. It is noted that tensioning the hose 114 and/or the power cable 118 while reeling in the hose 114 and/or the power cable 118 prevents the irrigation device 100 from being towards the stationary dock. In an example, when the irrigation device 100 does not follow the same path that the hose 114 and the power cable 118 are laid, the spool rolls the hose 114 and the power cable 118 back up at a speed that is different than the speed at the irrigation device 100 is moving. That said, in such an example, the speed at which the hose 114 and the power cable 118 are spooled onto the spool is selected to prevent tensioning of the hose 114 and the power cable 118 and to prevent too much slack in the hose 114 and the power cable 118. This coordinated unspooling and spooling with the spool also avoids dragging the hose 114 and power cable 118 through the grass (which may damage the grass, such as newly seeded grass) and allows the irrigation device 100 to go around corners and obstacles without tangling the hose 114 and power cable 118 in those obstacles. In an embodiment, the spool may also be used to give the irrigation device 100 extra pull towards the stationary dock when returning back to the stationary dock in the event that the irrigation device 100 loses traction in an area. The irrigation device 100 may use a single spool for both the hose 114 and the power cable 118, or separate spools for the hose 114 and power cable 118.

The irrigation device 100 may be configured to move the hose spool 116 relative to the housing 102. As such, the irrigation device 100 may include a bushings on which the hose spool 116 rides on and a motor (e.g., geared stepper motor) configured to rotate the hose spool 116.

The fluid delivery nozzle 112 may be disposed above the spool (e.g., the hose spool 116) to maximize the elevation of the fluid delivery nozzle 112 which, in turn, maximizes the distance that the fluid delivery nozzle 112 may dispense the fluid. In an embodiment, the spool may be connected to the fluid delivery nozzle 112 with a simple barbed connector. In an embodiment, the fluid delivery nozzle 112 may be connected to the spool using a swivel connector to allow the housing 102 and fluid delivery nozzle 112 to turn independent of the spool. In an embodiment, the spool may define a central channel for the hose 114 and/or power cable 118 to pass through such that the hose 114 may be in fluid communication with the fluid delivery nozzle 112 and/or the power cable 118 can provide power to the sensors (as discussed below). In an embodiment, the fluid delivery nozzle 112 may be disposed on a fixed (i.e., nonrotating) axle of the spool thereby allowing fluid delivery nozzle 112 to be directed towards a desired location even as the spool rotates. In an embodiment, the fluid delivery nozzle 112 may be disposed on a portion of the spool that is configured to rotate such that rotating the spool also changes the direction that the fluid delivery nozzle 112 faces. In such an embodiment, the irrigation device 100 may or may not include a separate actuator configured to change the direction that the fluid delivery nozzle 112 faces.

In an embodiment, the irrigation device 100 includes one or more sensors configured to detect one or more characteristics of at least one of the irrigation device 100 or the environment about the irrigation device 100. The characteristics detected by the sensors may be used to assess plant health, map terrain, plan routes, validate robot location, avoid obstacles, validate that the water stream is hitting the intended target, adjust the water stream to compensate for wind, etc.

In an embodiment, the sensors may include at least one light sensing sensor, such as a camera. In an example, the light sensing sensor may be configured to image obstacles or other features around the irrigation device 100. In such an example, the images may be used to navigate the irrigation device 100 around the obstacles or to selected features. In other words, the light sensing sensor is the “eyes” of the irrigation device 100 that is used to navigate the irrigation device 100. In an example, the light sensing sensor may be used to detect the conditions of plants (e.g., grass, flowers, etc.) around the irrigation device 100. In such an example, the light sensing sensor may be used to detect discoloration indicating over/under watering of the plants, damage caused by insects, damage caused by the drive system 106, etc. In an example, the sensors may include a moisture sensor configured to detect moisture levels on the grass or in the ground. In an example, the sensors may include GPS sensor configured to assist with determining location. In an example, the sensors may include at least one of a temperature sensor or humidity sensor which may be used to better calculate the amount of water to apply.

An optional lift mechanism may allow the sensors to be raised higher to see inside flower beds, pots, etc. The lift mechanism may allow the fluid delivery nozzle 112 and the sensors to be raised higher to see inside flower beds and pots, or get closer to plants and better observe and deliver fluid. The lift mechanism might be a simple scissor lift under the fluid delivery nozzle 112 and the sensors.

In an embodiment, the irrigation device 100 may include one or more stimuli sources that facilitate operation of the sensors. An example of a stimuli source includes one or more light emitting devices 120 (e.g., light emitting diodes) that to allow night operation and specific color analysis of plant health to measure chlorophyll or other health indicators.

In an embodiment, the irrigation device 100 includes a controller, for example, disposed in a computer housing box (e.g., the fluid tight compartment 104). The controller is configured to control one or more components of the irrigation device 100. The controller includes at least one processor and non-transitory memory storage. The non-transitory memory storage includes one or more operational instructions (e.g., programs) that may be executed by the processor. In an embodiment, the controller is communicably coupled to the sensors such that the controller may receive the characteristics detected by the sensors. The controller may controller may control the irrigation device 100 responsive to receiving the detected characteristics. In other words, the controller may assist with local processing of the images, for example, to minimize network bandwidth back to the centralized processing center. The controller may also control other aspects of the irrigation device 100, such as controlling the spooling and unspooling of the hose 114 and/or the power cable 118 to minimize tension in the hose and/or power cable 118 and to prevent too much slack forming in the hose 114 and/or the power cable 118.

A small, lightweight, low cost irrigation device 100 is used as the delivery mechanism for the irrigation system. The light weight and low cost of the irrigation device 100 may make the system cost effective, practical to build and less expensive to replace if damaged or stolen.

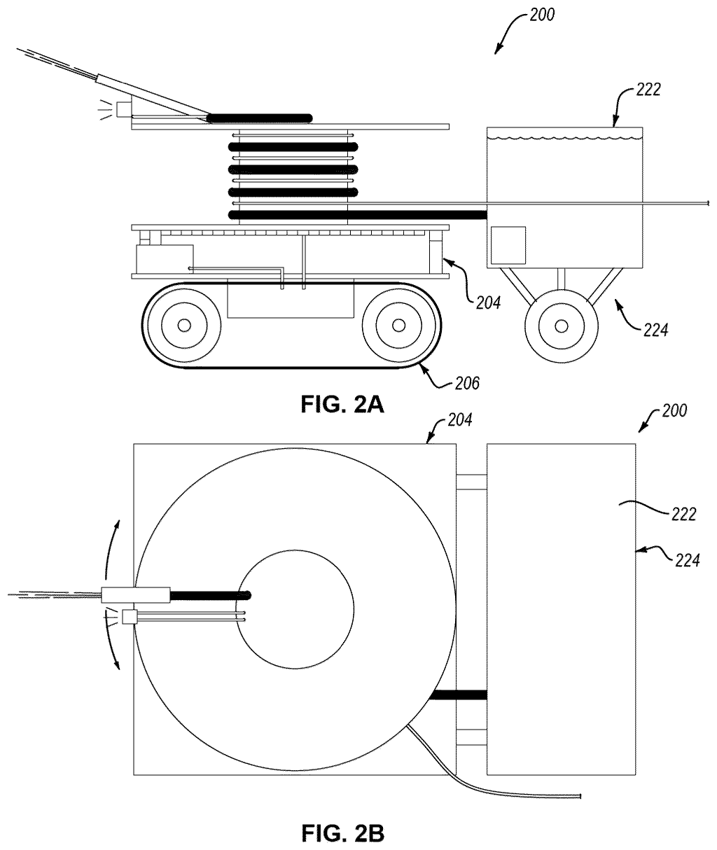

The irrigation device 100 illustrated in FIGS. 1A and 1B does not include a water tank. However, in some embodiments, the irrigation devices disclosed herein may include a water tank. For example, FIGS. 2A and 2B is side and top schematic views, respectively, of an irrigation device 200 that includes a water tank 222, according to an embodiment. Except as otherwise disclosed herein, the irrigation device of FIGS. 2A and 2B is the same as or substantially similar to any of the irrigation devices disclosed herein. The irrigation device 200 includes a water tank 222. In an embodiment, as illustrated, the water tank 222 may form part of a trailer 224 that is attached to and pulled behind the housing 204. The water tank 222 that forms part of a trailer 224 allows the water tank 222 to be used with any irrigation device regardless if the irrigation device is not designed to have a water tank 222. In other words, the water tank 222 that forms part of a trailer 226 may be an add-on to a housing 202 that is not configured to include a water tank 222 (e.g., a housing 202 that cannot support the weight of the water tank 222 or does not have space to include a water tank 222). In an embodiment, (not shown) the water tank 222 may be disposed on the housing 204.

In an embodiment, the water tank 222 allows the irrigation device 200 to operate independent of a hose. As such, the area watered by the irrigation device 200 does not depend on the length of the hose, the irrigation device 200 does not have to consider its path to avoid tangling the hose or move the hose around obstacles, and kinking the hose is not a concern. In an embodiment, the irrigation device 200 includes a hose extending to a stationary dock or a hose spigot (not shown) that allows a continuous supply of water to the irrigation device 200. In such an embodiment, the water tank 222 allows water to be dispensed from the irrigation device 200 when water supply from the hose is interrupted (e.g., due to kinking) or allows a specialized fluid (e.g., fertilizer or insecticide) to be dispensed from the irrigation device 200.

It is noted that the water tank 222 may increase the weight of the irrigation device 200 thereby requiring more power to move the irrigation device 200 and may decrease the speed at which the irrigation device 200 moves. The water tank 22 may also require refilling during operation thereby increasing the time required to irrigate a lawn.

The water tank 222 may exhibit any suitable volume, such as 100 milliliters (“ml”) or greater, about 200 ml or greater, about 300 ml or greater, about 400 ml or greater, about 500 ml or greater, about 750 ml or greater, about 1 liter (“L”) or greater, about 1.5 L or greater, about 2 L or greater, about 3 L or greater, about 4 L or greater, about 5 L or greater, about 7.5 L or greater, about 10 L or greater, about 12.5 L or greater, about 15 L or greater, about 20 L or greater, or in ranges of about 50 ml to about 200 ml, about 100 ml to about 300 ml, about 200 ml to about 400 ml, about 300 ml to about 500 ml, about 400 ml to about 750 ml, about 500 ml to about 1 L, about 750 ml to about 1.5 L, about 1 L to about 2 L, about 1.5 L to about 3 L, about 2 L to about 4 L, about 3 L to about 5 L, about 4 L to about 7.5 L, about 5 L to about 10 L, about 7.5 L to about 12.5 L, about 10 L to about 15 L, or about 12.5 L to about 20 L. The size of the water tank 222 may be selected for a variety of reasons. In an example, the size of the water tank 222 may depend on whether the water tank 222 is disposed on the housing 202 or a trailer 224 since the trailer 224 may be better able to handle larger water tanks 222 than the housing 202. In an example, the size of the water tank 222 may depend on the size and strength of the power system 206. In an example, the size of the water tank 222 may depend on the fluid stored therein. For instance, a smaller water tank 222 may be used to store a highly concentrated fertilizer while a larger water tank 222 may be used to store a diluted fertilizer or water.

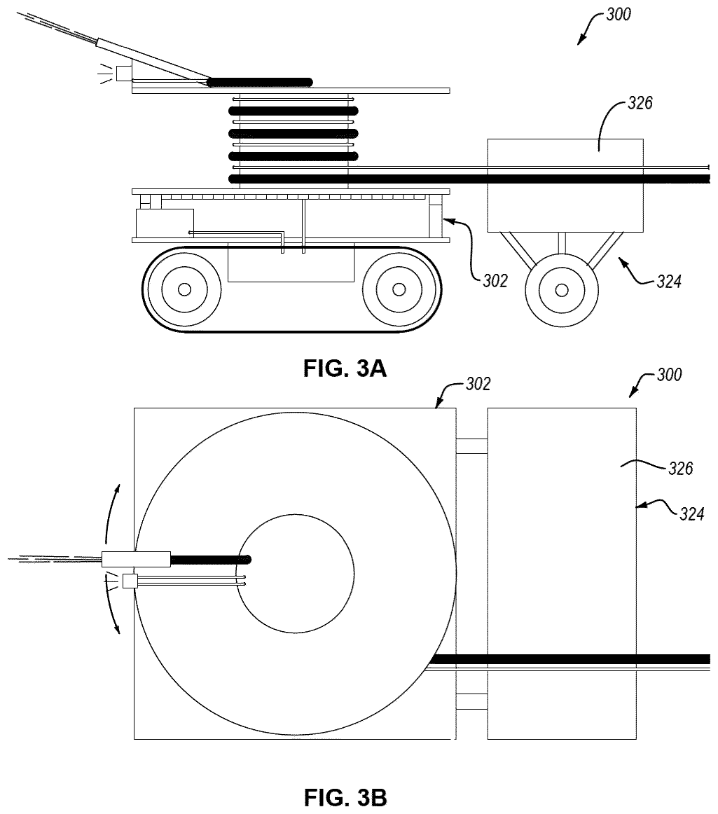

The irrigation devices illustrated in FIGS. 1A-2B do not include a battery but, instead, include a power cable that powers the irrigation device. However, in some embodiments, the irrigation devices disclosed herein may include a battery. For example, FIGS. 3A and 3B is side and top schematic views, respectively, of an irrigation device 300 that includes a battery 326, according to an embodiment. Except as otherwise disclosed herein, the irrigation device 300 of FIGS. 3A and 3B is the same as or substantially similar to any of the irrigation devices disclosed herein. The irrigation device 300 includes a battery 326. In an embodiment, as illustrated, the battery 326 may form part of a trailer 324 that is attached to and pulled behind the housing 302. The battery 326 that forms part of a trailer 324 allows the battery 326 to be used with any irrigation device regardless if the irrigation device is not designed to have a battery. In other words, the battery 326 that forms part of a trailer 324 may be an add-on to a housing 302 that is not configured to receive the battery 326 (e.g., the housing 302 cannot support the weight of the battery 306 or does not have space to receive the battery 326). In an embodiment, the battery may be disposed on the housing 302.

The battery 326 allows the irrigation device 300 to operate independent of a power cable that extends from the irrigation device 300 to a stationary dock or an electrical outlet. As such, the area watered by the irrigation device 300 does not depend on the length of the power cable and the irrigation device 300 does not have to consider its path to avoid tangling the power cable or move the power cable around obstacles. However, the battery 326 may increase the weight of the irrigation device 300 thereby requiring more power to move the irrigation device 300 and may decrease the speed at which the irrigation device 300 moves. The battery 326 may also require recharging during operation thereby increasing the time required to irrigate a lawn.

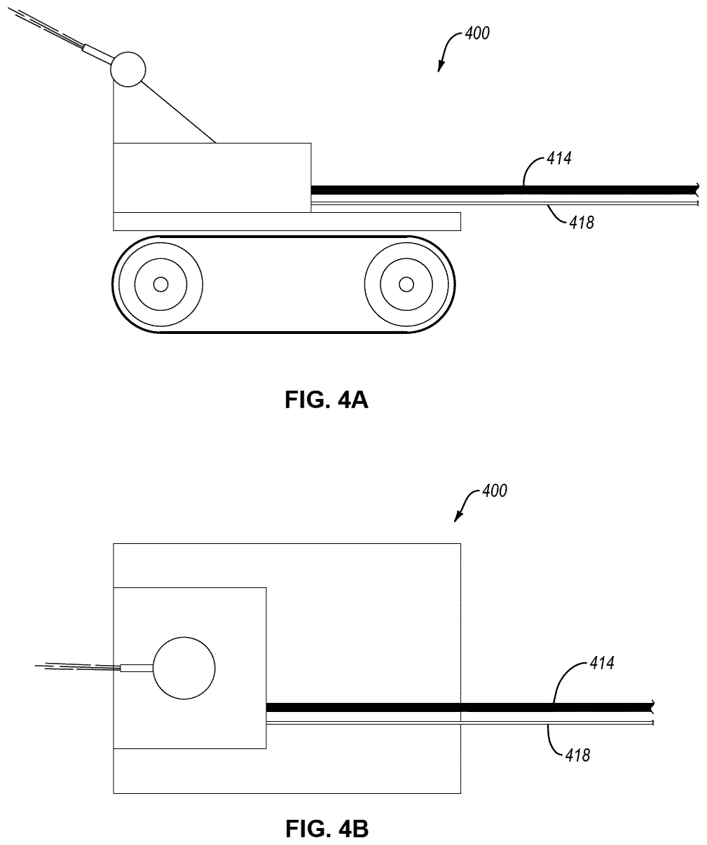

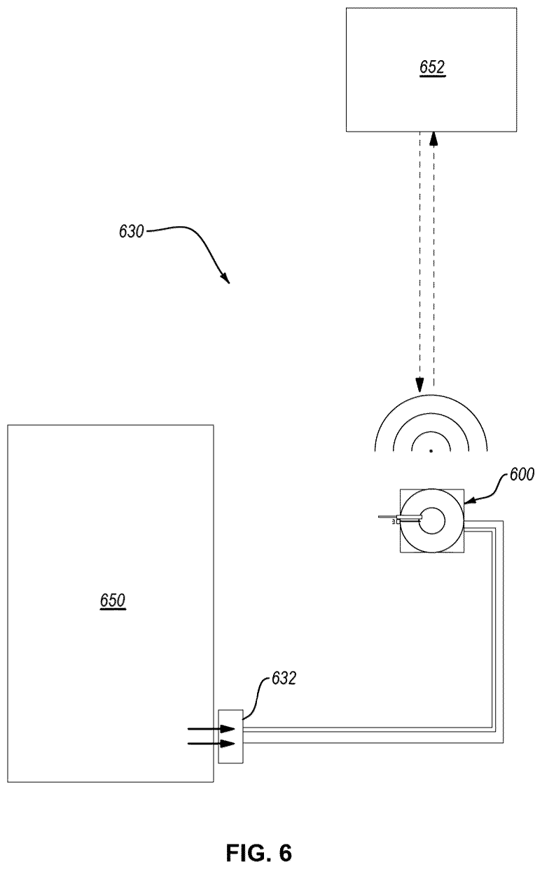

The irrigation devices illustrated in FIGS. 1A-3B include a spool. However, in some embodiments, the irrigation devices disclosed herein may not include a spool. For example, FIGS. 4A and 4B is side and top schematic views, respectively, of an irrigation device 400 that does not include a spool, according to an embodiment. Except as otherwise disclosed herein, the irrigation device 400 of FIGS. 4A and 4B is the same as or substantially similar to any of the irrigation devices disclosed herein. The irrigation device 400 does not include a spool which decreases the weight of the irrigation device 400 which may improve performance of the irrigation device 400. However, the irrigation device that does not include a spool may need to pull the hose 414 and power cable 418 instead of merely laying the hose 414 and power cable 418 down thereby requiring more power to move. In an embodiment, the irrigation device 400 forms part of a system that includes a stationary dock (see FIGS. 5 and 6). In such an embodiment, the stationary dock may include a spool that receives the hose 414 and power cable 418.

FIG. 5 is a schematic illustration of a system 530, according to an embodiment. The system 530 includes an irrigation device 500. The irrigation device 500 may include any of the irrigation devices disclosed herein. The system 530 also includes at least one stationary dock 532. The stationary dock 532 provides a resting place for the irrigation device 500 to return home as well as housing one or more components of the system 530.

The stationary dock 532 may include a power input connector 534 (e.g., cable with male electrical outlet adaptor) configured to connect to an electrical power source (e.g., an electrical outlet of a building, not shown). The stationary dock 532 may also include a water input connector 536 (e.g., a separate hose) configured to connect to a fluid (e.g., water) source, such as a spigot or conventional irrigation water supply system. Optionally, the stationary dock 532 includes a valve (not shown) configured to control fluid flow to the irrigation device 500. For example, the valve may turn the fluid flow on or off and/or vary the pressure of the fluid.

In an embodiment, the stationary dock 532 may include an optional primary tank 538 configured to store water therein, for example, if the stationary dock 532 loses a supply of water. The primary tank 538 may exhibit a volume of about 1 L to about 10 L. The stationary dock 532 may include a primary pump or valve 539 configured to control flow of a fluid into or out of the primary tank 538. In an embodiment, the stationary dock 532 may include one or more secondary tanks (e.g., secondary tanks 540a, 540b, 540c). The secondary tanks may be chemical tanks. The secondary tanks may contain or be configured to contain fertilizer, herbicides, insecticides, or other chemicals to be distributed from the stationary dock 538 to the irrigation device 500. One or more secondary pumps or valves (e.g., secondary pumps or valves 542a, 542b, 542c) may control distribution of chemicals from their respective secondary tank to the water supplied to the irrigation device 500 as directed by the controller 544 (e.g., the controller of the irrigation device 500, the controller of the secondary tank, or another controller). This ability to dynamically add chemicals to the water supply on demand is another significant advantage of using a tethered solution rather than a water tank on the irrigation device 500. In an example, the secondary tanks may include a level sensor configured to detect the remaining chemical levels in the secondary tanks and allow the system 530 to confirm usage of chemicals.

In an embodiment, the secondary tanks in may be configured to receive one or more removable cartridges. The removable cartridges may be prefilled with the chemicals and may to allow for easy self-service refill. In an example, the removable cartridges may include a machine readable identifying element (e.g., bar code, RFID tag, chip, etc.) that identifies the removable cartridge and the chemicals stored therein. In such an example, the stationary dock 532 may include at least one identifying detector (e.g., bar code scanner, RFID detector, etc.) configured to detect the identifying element. In an example, the level sensor configured to detect the remaining chemical levels in the cartridges and allow the system 530 to confirm usage of chemicals in the cartridges.

The stationary dock 532 may include a control and communication system to manage valves, read chemical cartridge IDs and labels, and assist the robot in communications with the central processing service.

FIG. 6 is a schematic of a system 630, according to an embodiment. The system 630 may include at least one irrigation device 600 and a stationary dock 632. The irrigation device 600 and the stationary dock 632 may include any of the irrigation devices and stationary docks disclosed herein. The stationary dock 632 may be coupled to a structure 650 (e.g., home, garage, shed, business, etc.) or any other source of a fluid and/or electrical power.

The system 630 also includes a centralized processing service 652. The centralized processing service 652 is spaced from the irrigation device 600, the stationary dock 632, the structure 650, and the area that the irrigation device 600 operates in. The centralized processing service 652 is configured to at least partially control the operation of the irrigation device 600 and/or the stationary dock 632. For example, the centralized processing service 652 is communicably coupled (e.g., wirelessly communicably coupled) to at least one of the irrigation device 600 or the stationary dock 630. Communicably coupling the centralized processing service 652 to at least one of the irrigation device 600 or the stationary dock 630 allows the centralize processing service 652 to receive data from the irrigation device 600 and/or the stationary dock 630, analyze the data, and, responsive to analyzing the data, control at least a portion of the operation of the irrigation device 600 and/or the stationary dock 632. For example, the centralized processing service 652 may receive data sensed by the sensors of the irrigation device 600. The centralized processing service 652 may analyze the received data to determine, for example, at least one of where the irrigation device 600 needs to water, if and where the irrigation device 600 needs to fertilize and/or spray insecticide, or a path the irrigation device 600 should follow to avoid obstacles. Responsive to the analysis, the centralized processing service 652 may direct the irrigation device 600 to at least one of water a desired location, provide fertilizer or insecticide to the desired location, or direct the irrigation device 600 to follow a specific path. In an embodiment, the centralized processing service 652 may control the operation of the irrigation device 600 and/or the stationary dock 652 responsive to data received from a source other than the irrigation device 600 and/or the stationary dock 652. For example, the centralized processing service 652 may receive a weather report for the area where the irrigation device 600 is located and may direct the irrigation device 600 to operate responsive to the weather report (e.g., direct the irrigation device 600 to water a desired location when the temperature is high or prevent the irrigation device 600 from watering a desired location when rain is forecasted).

In an embodiment, a centralized processing service 652 allows the irrigation device 600 and stationary dock 632 to have simpler and less expensive processing and computing capabilities. For example, the centralized processing service 652 may be configured to provide complex image processing, terrain mapping, and route planning instead of the irrigation device 600 and/or stationary dock 632. In other words, the centralized processing service 652 may allow one or more computing processes to be offloaded from the controller of the irrigation device 600 and/or stationary dock 632.

The centralized processing service 652 may also allow for manual intervention from one or more individuals that have access to the centralized processing service 652 (e.g., a homeowner or support center) when necessary. For example, in the case that the irrigation device 600 gets stuck or becomes confused, the individuals accessing the central processing service may review images of the current situation and provide manual instructions to the irrigation device 600 on how to proceed without requiring the owner to intervene. Manual intervention may also be useful during the initial setup of the irrigation device 600 and the rest of the system 630 to ensure proper setup.

A centralized processing service 652 may allow for expert tuning of the system 630. Lawn and plant experts with access to the centralized processing service 652, databases stored on the centralized processing service 652, or other applications of the centralized processing service 652 may be able to review current and historical images of lawn and plants as well as history of past care and then make recommendations on options for optimal future care. These recommendations may include more or less water, the application of specific chemicals, or even an on-site visit by professionals to handle more complex care or get a closer look at an issue. The centralized processing service 652 may issue these recommendations as commands that control the operation of the irrigation device 600.

A centralized processing service 652 may enable resilient tracking of lawn and plant care history. A history of variations in water and chemical delivery and resulting outcomes may be tracked by the central processing service to ensure that the history is not lost and the optimal tuning for every plant and every small section of lawn is preserved, even if owners change or equipment fails and is completely replaced.

A centralized processing service 652 may allow coordinated operation of multiple irrigation devices to divide up area to be irrigated and treated and find optimal routes and division of responsibility between the irrigation devices. This may even include adapting to the failure of one irrigation device and compensating with other irrigation devices such that all areas are consistently irrigated and treated.

A centralized processing service 652 may use machine learning to mass-analyze lawn and plant health data for similar regions and situations and automatically apply the optimal care for each situation.

While various aspects and embodiments have been disclosed herein, other aspects and embodiments are contemplated. The various aspects and embodiments disclosed herein are for purposes of illustration and are not intended to be limiting.

Terms of degree (e.g., “about,” “substantially,” “generally,” etc.) indicate structurally or functionally insignificant variations. In an example, when the term of degree is included with a term indicating quantity, the term of degree is interpreted to mean ±10%, ±5%, or ±2% of the term indicating quantity. In an example, when the term of degree is used to modify a shape, the term of degree indicates that the shape being modified by the term of degree has the appearance of the disclosed shape. For instance, the term of degree may be used to indicate that the shape may have rounded corners instead of sharp corners, curved edges instead of straight edges, one or more protrusions extending therefrom, is oblong, is the same as the disclosed shape, etc.

What is claimed is:

1. An irrigation device, comprising:
a housing;
at least one drive system configured to move the housing;
at least one fluid delivery nozzle disposed in or attached to the housing, the at least one fluid delivery nozzle configured to controllably and selectively dispense a fluid;
a controller configured to direction the at least one drive system to move the housing and the at least one fluid delivery nozzle to dispense the fluid; and
at least one of:
a hose attached to the housing and/or the housing includes a fluid inlet attachable to the hose, the hose configured to supply the fluid to at least one of the housing or the at least one fluid delivery nozzle, wherein the irrigation device does not include a fluid storage tank; or
a power cable attached to the housing and/or the housing includes a power inlet attachable to the power cable, the power cable configured to supply electrical power to one or more components housed in and/or attached to the housing, wherein the irrigation device does not include a device powering battery.

2. The irrigation device of claim 1, wherein the housing includes at least one fluid tight compartment, and wherein the controller is disposed in the at least one fluid tight compartment of the housing.

3. The irrigation device of claim 1, wherein the at least one drive system includes a plurality of wheels or at least one track disposed under the housing and at least one electric motor operably coupled to and configured to directly rotate one or more of the plurality of wheels or the at least one track.

4. The irrigation device of claim 3, where the at least one electric motor is disposed directly under or within the housing.

5. The irrigation device of claim 1, the at least one fluid delivery nozzle is disposed on or attached to an uppermost region of the housing, wherein the uppermost region of the housing is a region of the housing furthest spaced from the ground.

6. The irrigation device of claim 1, the at least one fluid delivery nozzle is moveable relative to the housing.

7. The irrigation device of claim 1, wherein the at least one fluid delivery nozzle exhibits 360° rotation in a plane parallel to a ground.

8. The irrigation device of claim 1, wherein the irrigation device includes the hose attached to the housing and/or the housing includes the fluid inlet attachable to the hose, the hose configured to supply the fluid to at least one of the housing or the at least one fluid delivery nozzle, wherein the irrigation device does not include the fluid storage tank.

9. The irrigation device of claim 1, wherein the irrigation device includes the power cable attached to the housing and/or the housing includes a power inlet attachable to the power cable, the power cable configured to supply electrical power to one or more components housed in and/or attached to the housing, wherein the irrigation device does not include a device powering battery.

10. The irrigation device of claim 1, further comprising at least one spooling device attached to the housing, the spooling device configured to receive and store at least a portion of at least one of the hose or the power cable.

11. The irrigation device of claim 1, further comprising one or more sensors configured to detect one or more characteristics of the irrigation device or an environment about the irrigation device, the one or more sensors communicably coupled to the controller.

12. The irrigation device of claim 11, further comprising a lifting device attached to the one or more sensors, the lifting device configured to move the one or more sensors relative to the housing.

13. A system, comprising:
an irrigation device, including:
a housing;
at least one drive system configured to move the housing;
at least one fluid delivery nozzle disposed in or attached to the housing, the at least one fluid delivery nozzle configured to controllably and selectively dispense a fluid;
a controller configured to direction the at least one drive system to move the housing and the at least one fluid delivery nozzle to dispense the fluid; and
at least one of:
a hose attached to the housing and/or the housing includes a fluid inlet attachable to the hose, the hose configured to supply the fluid to at least one of the housing or the at least one fluid delivery nozzle, wherein the irrigation device does not include a fluid storage tank; or
a power cable attached to the housing and/or the housing includes a power inlet attachable to the power cable, the power cable configured to supply electrical power to one or more components housed in and/or attached to the housing, wherein the irrigation device does not include a device powering battery; and
a stationary dock;
wherein at least one of:
the hose extends between and is attached to the irrigation device and the stationary dock; or
the power cable extends between and is attached to the irrigation device and the stationary dock.

14. The system of claim 13, wherein the stationary dock includes one or more secondary tanks.

15. The system of claim 14, wherein the one or more secondary tanks are configured to receive cartridges.

16. The system of claim 15, wherein the stationary dock includes at least one identifying device configured to identify the cartridges received thereby.

17. The system of claim 13, further comprising a centralized processing center spaced from the irrigation device and the stationary dock.

18. The system of claim 13, further comprising one or more additional irrigation devices.
